(19) United States
(12) Patent Application Publication
(10) Pub. No.: US 2007/0091595 A1
(43) Pub. Date: Apr. 26, 2007

(54) Display and backlight module thereof

(75) Inventors: Wen-Hsin Lin, Jhunan Township (TW); Hui-Kai Chou, Taipei City (TW); Chang-Ho Shen, Hsinchu City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/389,645

(22) Filed: Mar. 24, 2006

(30) Foreign Application Priority Data
Oct. 20, 2005 (TW) 94136681

(51) Int. Cl. F21Y 103/025; F21S 4/00

(52) U.S. Cl. 362/216; 362/225; 362/260

(57) ABSTRACT

A display and a backlight module thereof are provided. The backlight module comprises a substrate, a supporting element, and at least one U-shaped lamp installed over the substrate. The substrate has a bottom surface. The U-shaped lamp comprises two ends and a curved portion for forming a reference surface. The reference surface and the bottom surface form an included angle.

This application claims the priority benefit of Taiwan application serial no. 94136681, filed Oct. 20, 2005. All disclosure of the Taiwan application is incorporated herein by reference.

### BACKGROUND OF THE INVENTION

1. Field of the Invention

The invention relates to a display and a backlight module thereof, and in particular relates to an arrangement of U-shaped lamps.

2. Description of the Related Art

Referring to FIGS. 1, 2 and 2A, a conventional backlight module 10 comprises a substrate 11, a bottom surface 12, a plurality of U-shaped lamps 13 and a region 14 for setting a supporting element (not shown) to support the U-shaped lamps 13. FIG. 2A shows the U-shaped lamps 13 of the conventional backlight module disposed in the substrate 11 and parallel to the bottom surface 12.

The current purchasing trend is towards large size displays. However, the arrangement of the U-shaped lamps of the conventional backlight module 10 does not provide adequate illumination for a large size display. To generate adequate illumination in a large size display, a manufacturer adds a prism sheet (not shown) in a backlight module, which increases cost. Moreover, a prism sheet may wrinkle, thus decreasing display quality because of high temperature from a backlight module. The invention provides a solution to the above problems.

### BRIEF SUMMARY OF THE INVENTION

A detailed description is given in the following embodiments with reference to the accompanying drawings. The invention provides a display and backlight module thereof. The backlight module comprises a substrate, supporting element and a plurality of U-shaped lamps. The substrate comprises a bottom surface. The U-shaped lamp is installed over the substrate. Two ends and a curved portion of the U-shaped lamp form a surface. The surface and the bottom form an included angle.

In one embodiment, when there is a plurality of U-shaped lamps, the open directions of all U-shaped lamps are toward the same direction.

In another embodiment, when there is a plurality of U-shaped lamps, the open directions of each two U-shaped lamps are toward the reverse direction.

In another embodiment, the backlight module further comprises at least a straight lamp. The U-shaped lamp overlaps the straight lamp.

### BRIEF DESCRIPTION OF DRAWINGS

The invention can be more fully understood by reading the subsequent detailed description and examples with references made to the accompanying drawings, wherein:

FIG. 1 is a schematic view showing a conventional backlight module;

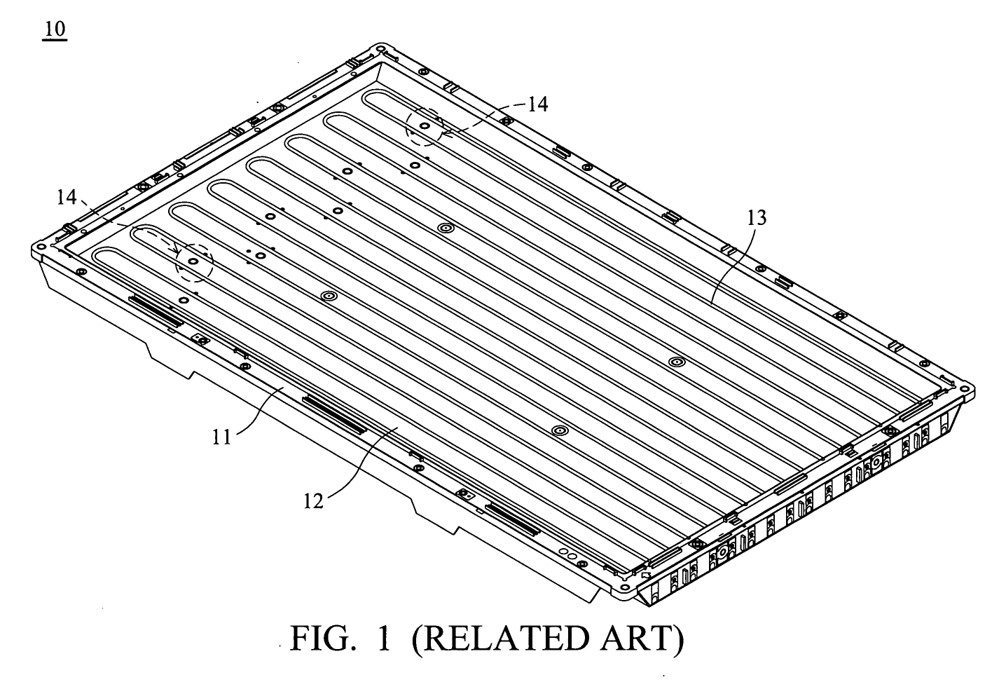

FIG. 2 is a vertical view showing a conventional backlight module;

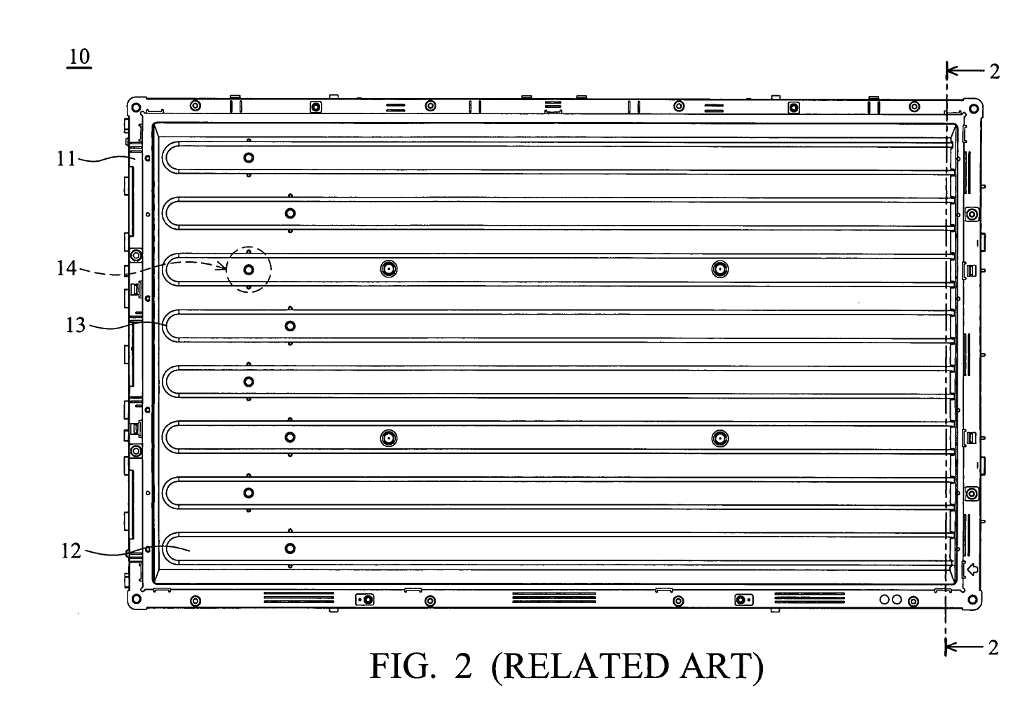

FIG. 2A is a cross-sectional view along line 2-2 of FIG. 2;

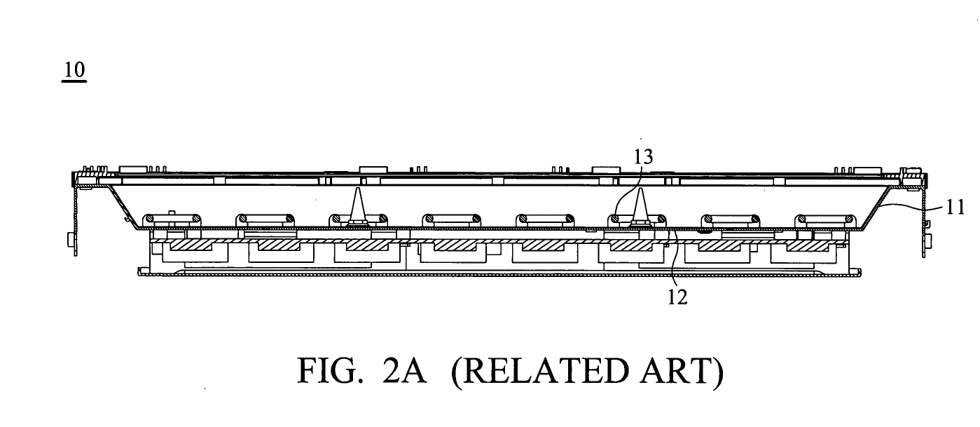

FIG. 3 is a schematic view of an embodiment of the invention;

FIG. 4 is a vertical view of an embodiment of the invention;

FIG. 4A is a cross-sectional view along line 4-4 of FIG. 4;

FIG. 5 is a schematic view of another embodiment of the invention;

FIG. 5A is a cross-sectional view along line 5-5 of FIG. 5;

FIG. 6 is a schematic view of another embodiment of the invention;

FIG. 6A is a cross-sectional view along line 6-6 of FIG. 6;

FIG. 7 is a schematic view of another embodiment showing the substrate connects to the bottom surface; and

FIG. 8 is a schematic view showing the open direction of the U-shaped lamp.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

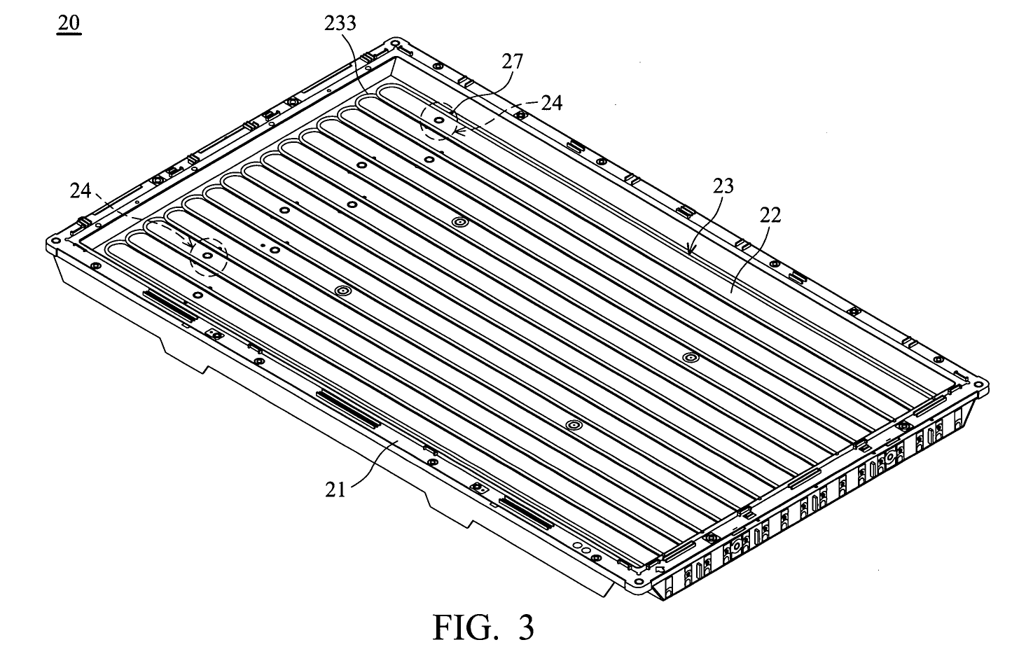

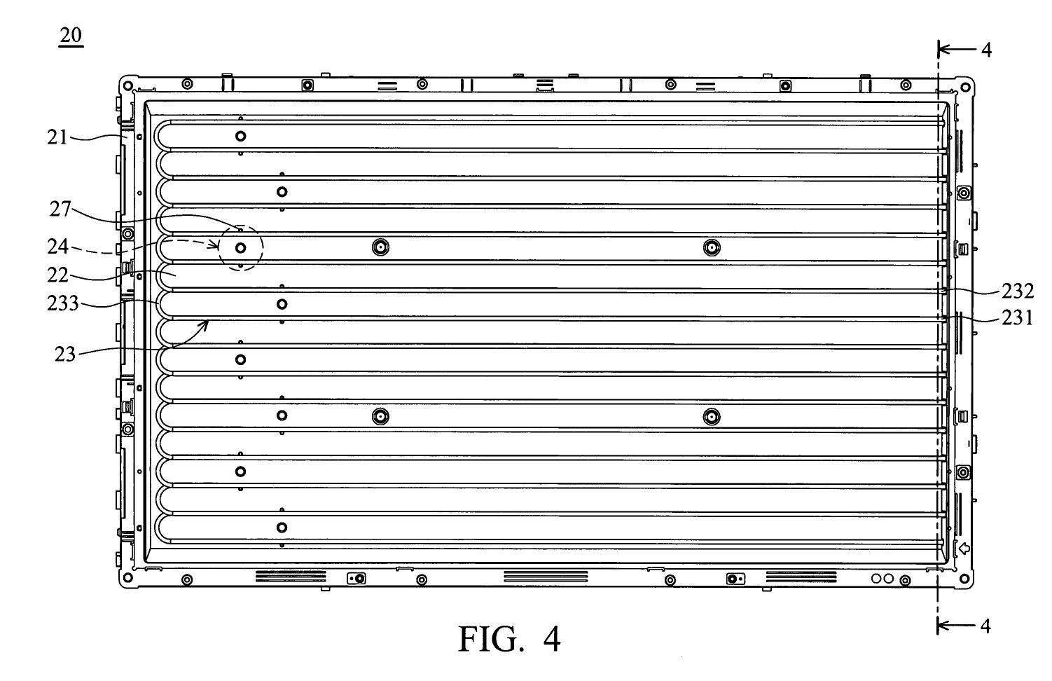

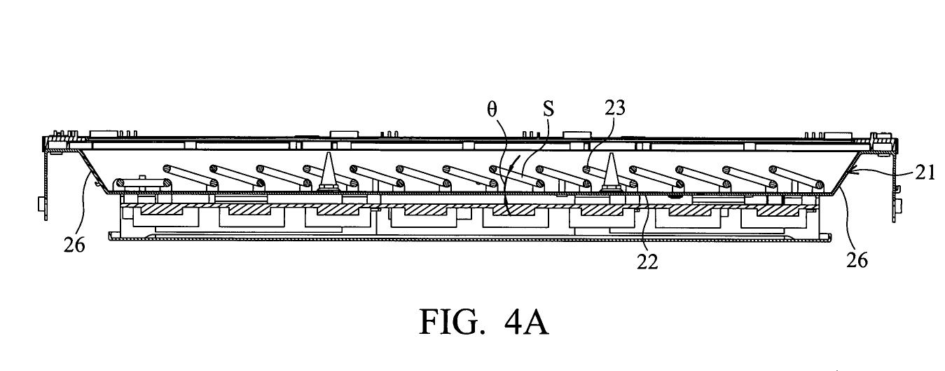

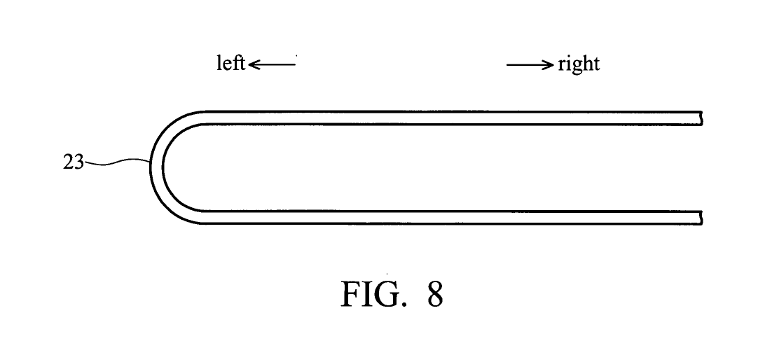

Referring to FIGS. 3, 4 and 4A, a backlight module 20 comprises a substrate 21, a region 14 and a plurality of U-shaped lamps 23. A plurality of supporting elements 27 are installed in the region 24 for supporting the U-shaped lamps 23. In this embodiment, the substrate 21 is a frame which comprises a bottom surface 22. FIG. 4 shows each U-shaped lamp comprises two ends 231 and 232 and a curved portion 233 for forming a reference plane S (shown by FIG. 4A), wherein the reference plane S and the bottom surface 22 form an included angle θ. In the other word, the reference plane S is non-parallel to the bottom surface 22. Moreover, two electrodes are installed on the ends 231 and 232. In FIG. 8, the open direction of the U-shaped lamp 23 is toward the right, thus, FIG. 4 shows the open direction of all U-shaped lamps are toward the same direction (arranged in the same direction). The included angle θ ranges from 0 degrees to 90 degrees. The substrate 21 further comprises a side surface 26 connected to the bottom surface 22. Noted that the U-shaped lamp 23 may be a cold cathode fluorescence lamp (CCFL) or an external electrode fluorescence lamp (EEFL).

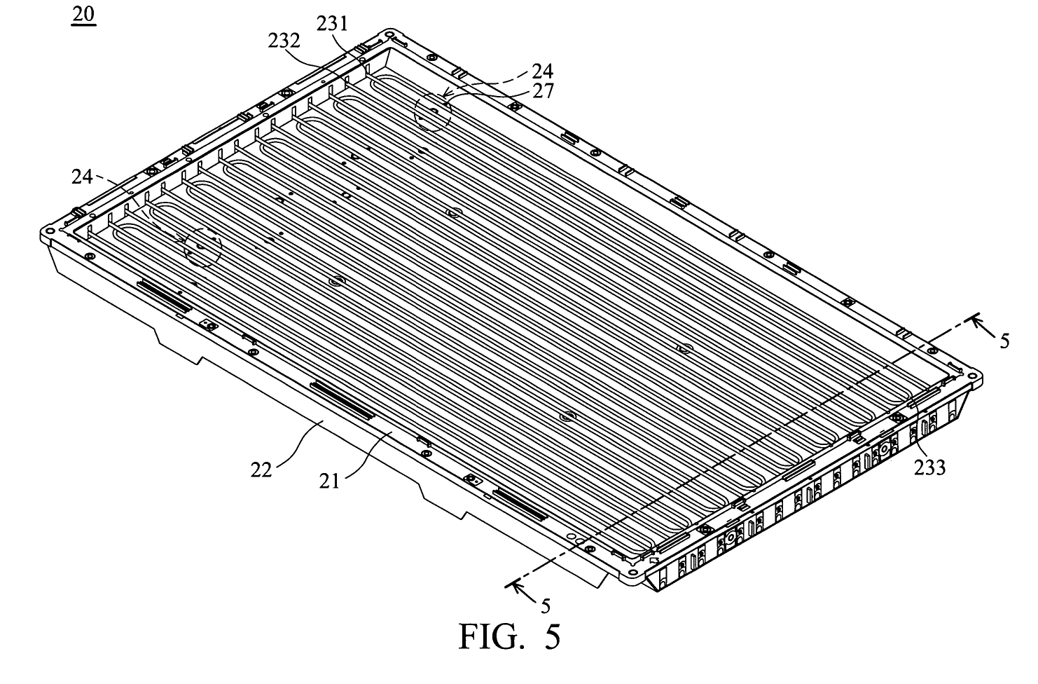

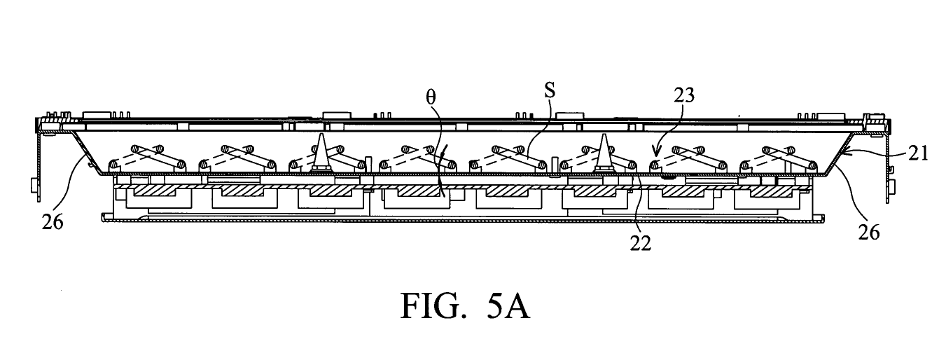

FIGS. 5 and 5A show another embodiment. A backlight module 20 comprises a substrate 21, a region 24 and a plurality of U-shaped lamps 23. A plurality of supporting elements 27 are installed in the region 24 for supporting the U-shaped lamps 23. In this embodiment, the substrate 21 is a frame which comprises a bottom surface 22. FIG. 4 shows each U-shaped lamp comprises two ends 231 and 232 and a curved portion 233 for forming a reference plane S (shown by FIG. 5A), wherein the reference plane S and the bottom surface 22 forms an included angle θ. In the other word, the reference plane S is non-parallel to the bottom surface 22. Moreover, two electrodes are installed on the ends 231 and 232. In FIG. 8, the open direction of the U-shaped lamp 23 is toward the right, thus, FIG. 5 shows that the open directions of each two U-shaped lamps are toward the reverse direction (arranged in the reverse direction). The included angle θ ranges from 0 degrees to 90 degrees. The substrate 21 further comprises a side surface 26 connected to the bottom surface 22.

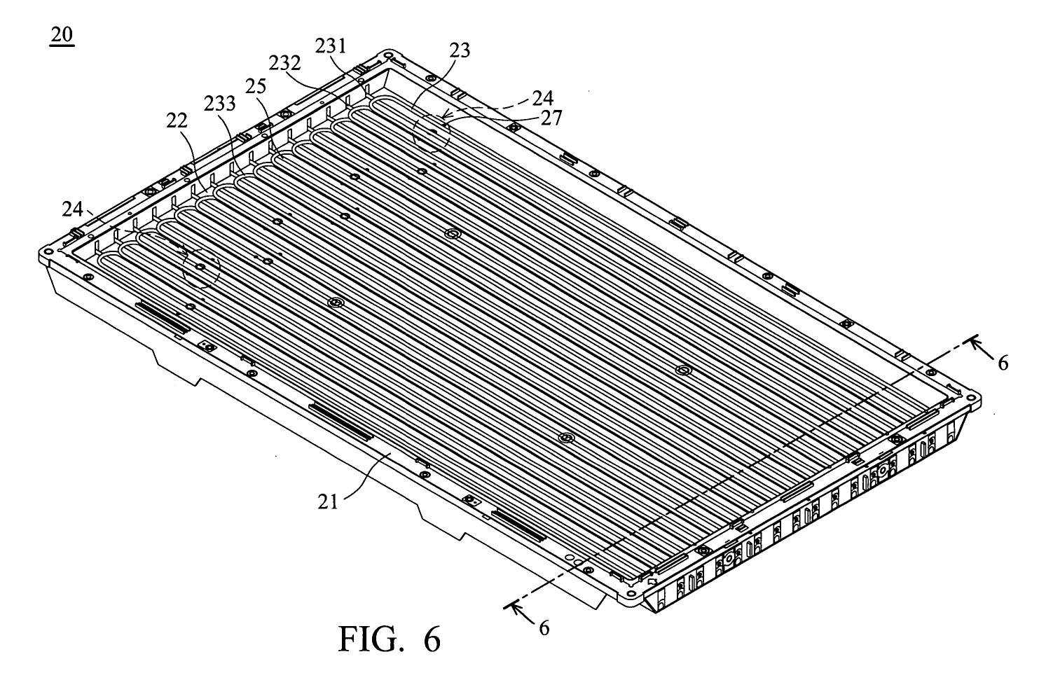

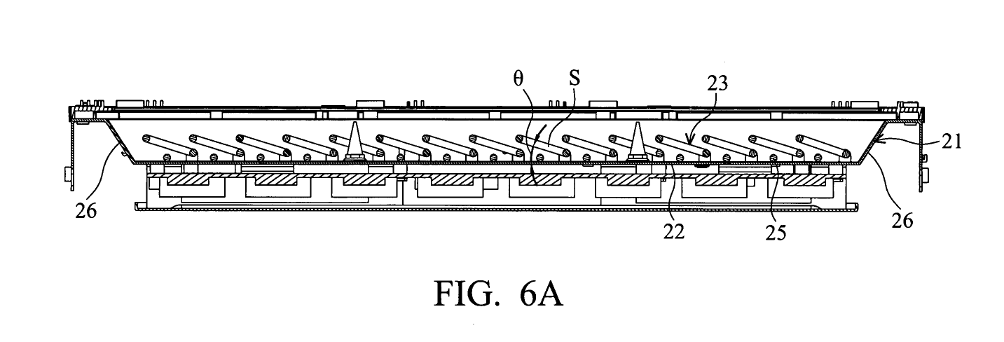

FIGS. 6 and 6A show another embodiment. A backlight module 20 comprises a substrate 21, a region 24, a plurality of U-shaped lamps 23 and a plurality of straight lamps 25. A plurality of supporting elements 27 are installed in the region 24 for supporting the U-shaped lamps 23. In this embodiment, the substrate 21 is a frame which comprises a bottom surface 22. FIG. 4 shows that each U-shaped lamp comprises two ends 231 and 232 and a curved portion 233 for forming a reference plane S (shown by FIG. 6A), wherein the reference plane S and the bottom surface 22 forms an included angle θ. In other words, the reference plane S is non-parallel to the bottom surface 22. Moreover, two electrodes are installed on the ends 231 and 232. In FIG. 8, the open direction of the U-shaped lamp 23 is toward the right, thus, FIG. 6 shows the open directions of all U-shaped lamps 23 are toward the same direction (the same direction arrangement). The straight lamp 25 overlaps the U-shaped lamp 23. The included angle θ ranges from 0 degree to 90 degree. The substrate 21 further comprises a side surface 26 connected to the bottom surface 22.

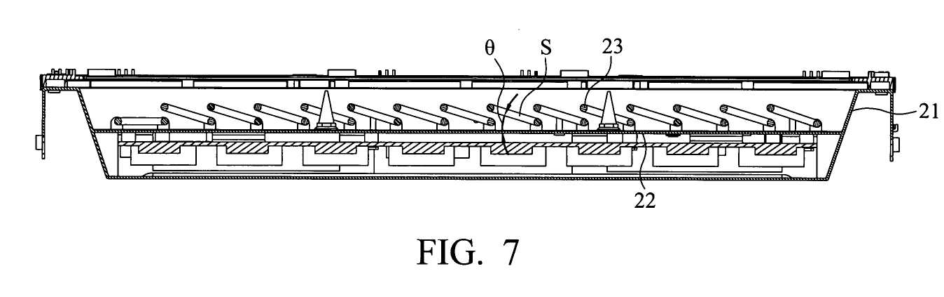

FIG. 7 shows another embodiment. This embodiment is substantially similar to the embodiment of FIGS. 3 and 4. The difference between this embodiment and the embodiment of FIGS. 3 and 4 is that the substrate 21 and the surface 22 are a single and unitary member.

The invention provides a display which contains more U-shaped lamps than a conventional display. The invention does not require additional prism sheet to supply adequate illumination for a backlight module, thereby problems associated with the prism sheet are eliminated.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A backlight module for a display, comprising:
a substrate having a bottom surface; and
at least one U-shaped lamp, having two ends and a curved portion, installed over the substrate;
wherein the two ends and the curved portion are situated at a reference plane non-parallel to the bottom surface;
wherein the at least one U-shaped lamp comprises a cold cathode fluorescence lamp (CCFL) or an external electrode fluorescence lamp (EEFL).

2. The backlight module as claimed in claim 1, wherein the number of the at least one U-shaped lamp is plural and two adjacent U-shaped lamps are interlaced.

3. The backlight module as claimed in claim 1, wherein the number of the at least one U-shaped lamp is plural and all the U-shaped lamps are arranged in a same direction.

4-6. (canceled)

7. The backlight module as claimed in claim 1, further comprising a supporting element disposed on the substrate to support the at least one U-shaped lamp.

8. The backlight module as claimed in claim 1, the substrate is a frame.

9. A display comprising the backlight module as claimed in claim 1.

10. A backlight module, comprising:
a substrate having a bottom surface;
at least one U-shaped lamp, having two ends and a curved portion, installed over the substrate; and
at least one straight lamp over the substrate to overlap the at least one U-shaped lamp;
wherein the two ends and the curved portion are situated at a reference plane non-parallel to the bottom surface.

11. The backlight module as claimed in claim 10, wherein the number of the at least one U-shaped lamp is plural and two adjacent U-shaped lamps are interlaced.

12. The backlight module as claimed in claim 10, wherein the number of the at least one U-shaped lamp is plural and all the U-shaped lamps are arranged in a same direction.

13. The backlight module as claimed in claim 10, further comprising a supporting element disposed on the substrate to support the at least one U-shaped lamp.

14. The backlight module as claimed in claim 10, the substrate is a frame.

15. The backlight module as claimed in claim 10, wherein the at least one U-shaped lamp comprises a cold cathode fluorescence lamp (CCFL) or an external electrode fluorescence lamp (EEFL).
